(19) United States
(12) Patent Application Publication
(10) Pub. No.: US 2026/0055922 A1
(43) Pub. Date: Feb. 26, 2026

(54) AIR CONDITIONING DRAIN CLEANOUT MANIFOLD

(71) Applicant: 50 50 Holdings, inc., Boca Raton, FL (US)

(72) Inventor: Alan RIDDLE, Boca Raton, FL (US)

(21) Appl. No.: 18/865,209

(22) PCT Filed: May 12, 2023
(86) PCT No.: PCT/US2023/066939

§ 371 Date: Nov. 12, 2024

Related U.S. Application Data
(60) Provisional application No. 63/341,498, filed on May 13, 2022.

(51) Int. Cl. F24F 13/22; B08B 9/035; F16L 41/03

(52) U.S. Cl. CPC F24F 13/222; B08B 9/035; F16L 41/03

(57) ABSTRACT

An aftermarket air conditioning drain cleanout manifold comprising a pipe with a one-piece continuous wall with a first and second end. The pipe is in fluid communication with a first threaded opening perpendicular to the one-piece continuous wall and adjacent to the first end. The pipe includes a second threaded opening perpendicular to the one-piece continuous wall and adjacent to the first threaded opening. The pipe includes a third threaded opening perpendicular to the one-piece continuous wall and adjacent to the second threaded opening and a slot formed within the opening of the third threaded opening and perpendicular to the one-piece continuous wall of the pi The pipe includes a fourth opening perpendicular to the one-piece continuous wall and adjacent to the third threaded opening. A flexible member is disposed in the slot, and a threaded plug is adapted to engage the third threaded opening to form a shut-off valve.

### CROSS-REFERENCE TO RELATED APPLICATIONS

This application claims priority from and is related to PCT Application No. PCT/US23/66939, entitled “Air Conditioning Drain Cleanout Manifold’, filed on May 12, 2023, with attorney docket number 9305-10001-WO, which claims priority from and is related to U.S. Provisional Application No. 63/341,498, entitled “Air Conditioning Drain Cleanout Manifold” with attorney docket number 9305-V0001, filed May 13, 2022. Each of the aforementioned patent applications is hereby incorporated into the present application by reference in their entirety.

### BACKGROUND

The present invention generally relates to heating, ventilation, and air conditioning (HVAC) systems and, more specifically to air conditioning drain lines.

Besides cooling the air, air conditioners (AC) also help dehumidify air. This process involves removing water moisture from the air. This moisture is collected in a large drain pan hidden away inside the AC system below the system's evaporator coil.

Every once in a while, however, the drain pipes become clogged with debris and dirt, in which case they will no longer be able to remove the water effectively. Considering that a single HVAC unit can collect up to 20 gallons of condensed water a day, it's not hard to imagine the damage that could occur if the water could not be adequately drained.

A float switch is essentially an electronic water sensor for the AC system. The float switch gives the AC system the ability to detect if it has a clogged drain, and if the switch detects a clogged drain scenario, it immediately shuts the system off.

Air conditioning (AC) drain lines, or condensate lines often clog and must be cleaned out to ensure proper operation of the AC unit. Dirt and bacteria growth contribute to drain lines being clogged. Once the AC drain line gets clogged, it's probably going to happen again and again. This is because it's so hard to clear out the entire drain line once the slime and sludge begin to form, dry, and harden and form again. When this happens, over the course of time between heating and cooling seasons, when the AC system isn't running or draining any water, the moist slime and sludge will harden into a calcium-like substance. Then, once the cooling season rolls around again and the AC system kicks on, the drain will quickly form another layer of slime on top of this hard calcium-like layer from the year before and clog.

Professional AC personnel and do-it-your-self homeowners use a variety of techniques to clean out these drain lines. These techniques include using a vacuum, compressed air, and additives such as vinegar and chlorine. Often times, air and vacuum techniques are ineffective because an airtight seal is not created near the drain pan. Without an airtight seal, air escapes through an opening in the drain pan.

Accordingly, a need exists to clean out AC drain lines.

### SUMMARY

Disclosed is a novel air conditioning drain cleanout manifold. In one embodiment, the manifold includes a pipe with a first end and a second end, the pipe formed with a first tee portion with a first threaded opening formed adjacent to the first end and a second tee portion formed with a second threaded opening formed adjacent to the first tee portion. One of the first threaded openings, the second threaded openings, or both is formed with pipe threads to threadably and fluidly coupled with a hose bib.

The manifold may also include one of the first threaded openings, the second threaded opening, or both is formed with pipe threads to threadably and fluidly coupled with a compressed air portion.

The manifold further includes a shut-off valve formed adjacent to the second tee portion and the second end, so that the first end, the first tee portion, the first threaded opening, the second tee portion, the second threaded opening, the shut-off valve, and the second end are all in fluid communications.

A third tee portion formed may be included on the side of the shut-off valve that is opposite the second tee portion and in fluid communications therewith.

In another embodiment, disclosed is an aftermarket air conditioning drain cleanout manifold. The manifold includes a pipe fabricated with a one-piece continuous wall with a first end and a second end. In one example, the pipe is fabricated using an injection mold or extrusion process. In another example, the pipe is fabricated using an additive manufacturing process. The pipe is fabricated out of plastic, metal, composite, or a combination thereof.

The pipe formed is in fluid communication with a first threaded opening formed perpendicular to the one-piece continuous wall and adjacent to the first end. The pipe formed is in fluid communications, with a second threaded opening formed perpendicular to the one-piece continuous wall and adjacent to the first threaded opening. The pipe formed is in fluid communications with a third threaded opening formed perpendicular to the one-piece continuous wall and adjacent to the second threaded opening and a slot formed within the opening of the third threaded opening and perpendicular to the one-piece continuous wall of the pipe. The pipe formed is in fluid communications, with a fourth opening formed perpendicular to the one-piece continuous wall and adjacent to the third threaded opening.

The first threaded opening, the second threaded opening, or both may be formed with female garden hose threads to threadably and fluidly coupled with a garden hose bib. In another example, the one of the first threaded opening, the second threaded opening, or both is formed with pipe threads to threadably and fluidly coupled with a ¼ inch national pipe tapered (NPT) threaded male compressed air plug. In still another example, the fourth threaded opening has a ¾ inch opening to accept a vertical float switch thereinto. Another example one of the first threaded opening, the second threaded opening, or both are formed with female garden hose threads to threadably and fluidly coupled with a garden hose bib. In this example, one of the first threaded opening, the second threaded opening, or both is formed with pipe threads to threadably and fluidly coupled with a ¼ inch national pipe tapered (NPT) threaded male compressed air plug. The fourth opening has an ¾ inch opening to accept a vertical float switch thereinto.

A flexible member is disposed in the slot, and a threaded plug is adapted to engage the third threaded opening to form a shut-off valve. In one example, the flexible member is cube-shaped or cuboid-shaped. The flexible member is fabricated out of plastic, metal, composite, or a combination thereof.

### BRIEF DESCRIPTION OF THE SEVERAL VIEWS OF THE DRAWINGS

The accompanying figures wherein reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a side view of a first embodiment of an air conditioning drain cleanout manifold, according to one aspect of the present invention;

FIG. 2 is a side view of a second embodiment of an air conditioning drain cleanout manifold, according to one aspect of the present invention;

FIG. 3 is a side explosion view of FIG. 2 illustrating various adapters fluidly coupled to the air conditioning drain cleanout manifold, according to one aspect of the present invention;

FIG. 4 is a side view of a third embodiment of an air conditioning drain cleanout manifold, according to one aspect of the present invention;

FIG. 5 is a side view of a fourth embodiment of an air conditioning drain cleanout manifold, according to one aspect of the present invention;

FIG. 6 is a first perspective view of the first embodiment of the air conditioning drain cleanout manifold without the various adapters, according to one aspect of the present invention;

FIG. 7 is a second perspective view of FIG. 6, according to one aspect of the present invention;

FIG. 8 is a first side plan view of FIG. 6, according to one aspect of the present invention;

FIG. 9 is a second side plan view of FIG. 6, according to one aspect of the present invention;

FIG. 10 is a first end view of FIG. 6, according to one aspect of the present invention;

FIG. 11 is a second end view of FIG. 6, according to one aspect of the present invention;

FIG. 12 is a top view of FIG. 5, according to one aspect of the present invention;

FIG. 13 is a bottom view of FIG. 6, according to one aspect of the present invention;

FIG. 14 is a perspective view of a fifth embodiment of an air conditioning drain cleanout manifold, according to one aspect of the present invention;

FIG. 15 is a top view FIG. 14, according to one aspect of the present invention;

FIG. 16 is a bottom view FIG. 14, according to one aspect of the present invention;

FIG. 17 is a first end view of FIG. 14, according to one aspect of the present invention;

FIG. 18 is a second end view of FIG. 14, according to one aspect of the present invention;

FIG. 19 is a first side view of FIG. 14, according to one aspect of the present invention;

FIG. 20 is a second side view of FIG. 14, according to one aspect of the present invention;

FIG. 21 is a side explosion view of FIG. 14 illustrating various adapters fluidly coupled to the air conditioning drain cleanout manifold, according to one aspect of the present invention;

FIG. 22 is a perspective view of the threaded plug of FIG. 21, according to one aspect of the present invention; and

FIG. 23 is a perspective view of the flexible member adapted to fit into the slot of FIG. 14, according to one aspect of the present invention.

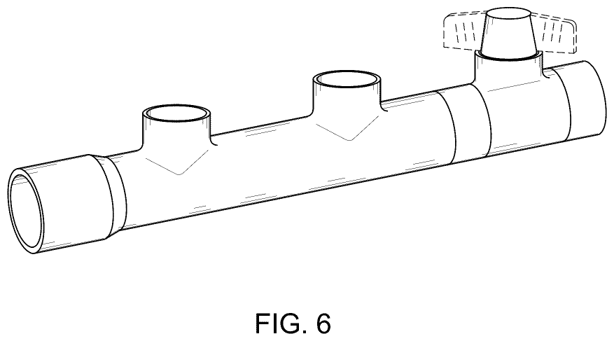

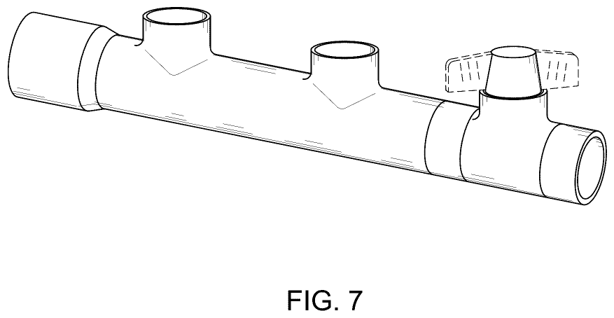

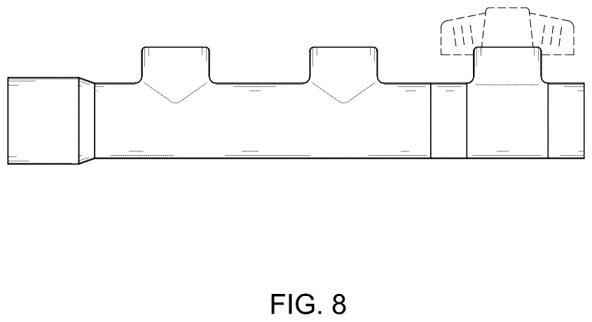

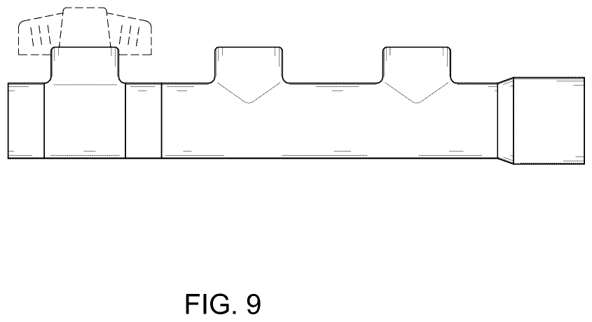

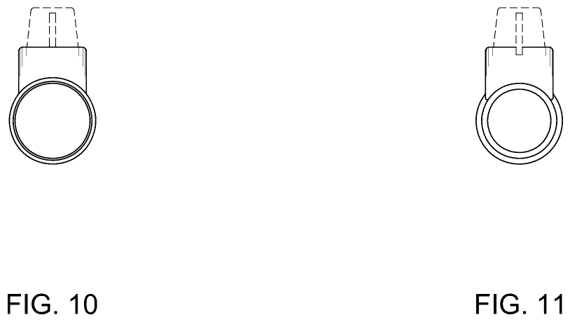

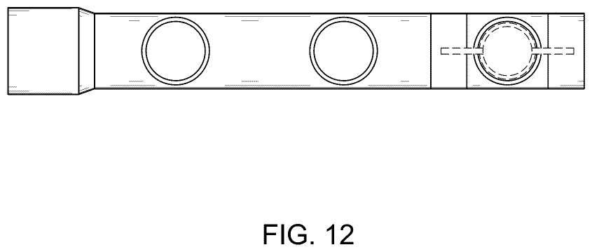

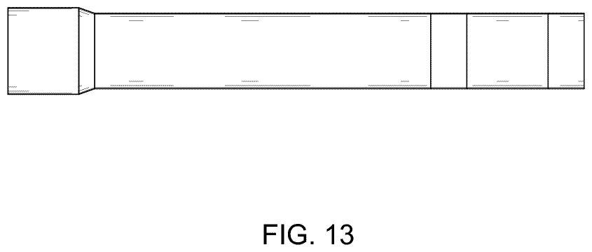

Note that the broken lines are shown in FIGS. 6-23 and are included for the purpose of illustrating portions of the article and form no part of the claimed design.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting but merely as a basis for the claims and as a representative basis for teaching one skilled in the art to variously employ the present subject matter in virtually any appropriately detailed structure and function. Further, the terms and phrases used herein are not intended to be limiting but rather, to provide an understandable description of the concepts.

The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application and to enable others of ordinary skill in the art to understand the invention for various embodiments with various modifications as are suited to the particular use contemplated.

### Non-Limiting Definitions

The terms “a”, “an” and “the” are intended to include the plural forms as well unless the context clearly indicates otherwise.

The term “aftermarket” refers to HVAC parts and accessories used to enhance the original HVAC product.

The phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The terms “comprises” and/or “comprising”, when used in this specification, specify the presence of stated features, steps, operations, elements, and/or components but do not preclude the presence or addition of one or more other features, integers, steps, operations, elements, components, and/or groups thereof.

The term “configured to” describes the hardware, software, or a combination of hardware and software that is adapted to, set up, arranged, built, composed, constructed, designed, or that has any combination of these characteristics to carry out a given function.

The term “adapted to” describes the hardware, software, or a combination of hardware and software that is capable of, able to accommodate, to make, or that is suitable to carry out a given function.

The term “coupled”, as used herein, is defined as “connected,” although not necessarily directly and not necessarily mechanically.

The terms “fluidly coupled”, “fluidly connected” and “fluid communications” means fluid, such as air and water, is able to flow from one component to another, but the two components need not be physically connected to one another.

The term “garden hose thread” (GHT) is “National Hose” as defined in ANSI B1.20.7. There are two designations. NHR is for thin-walled couplers on hoses formed from rolled, thin material and NH is for full-form threads cut into thicker material, typically used for bib cocks and female hose ends. Male threads for garden hoses are also abbreviated as MHT for “male hose thread” and female threads as FHT for “female hose thread”. Fittings have an external thread diameter of 1 1/16″, with a thread pitch of 11.5 threads per inch (TPI). A ¾ inch GHT fitting is suitable for hoses with an internal diameter of ½″, ⅝″ or ¾″. GHT is not compatible with National Pipe Tapered (NPT), which is used for plumbing fittings. NPT threads however are used on the section of a bibcock that connects to the plumbing that feeds it.

The terms “including” and “having,” as used herein, are defined as comprising (i.e., open language).

### Overview

The present invention is an AC drain line cleanout manifold. Various adapters can be attached to the manifold to fluidly couple with compressed air portions, water or garden hoses, and vacuum adapters. Using the present invention, the AC drain line can be cleaned out quickly and easily. The present invention can be temporarily installed or permanently installed. Ends of the manifold may be formed as bell ends as described below or with removable couplers to allow temporary installation.

### Example 1 of AC Drain Line Cleanout Manifold

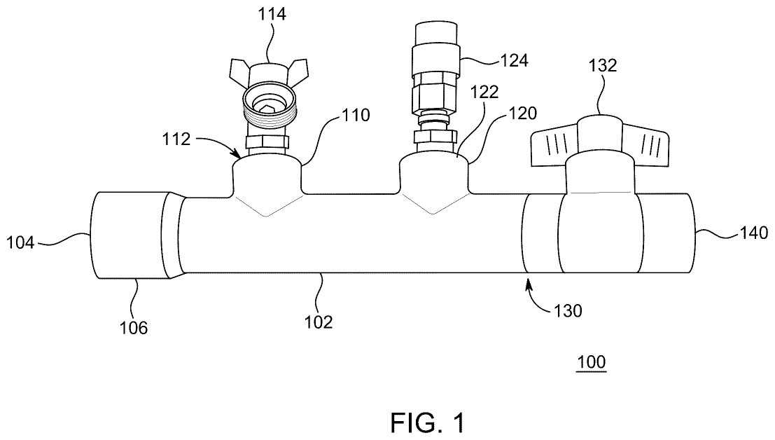

Turning to FIG. 1 shown is a side view of a first embodiment of an air conditioning drain cleanout manifold 100, according to one aspect of the present invention. In one example, this is an aftermarket accessory. In this embodiment, the manifold 100 includes a pipe 102 with two threaded tee portions 110, 120 and shut-off valve portion 132. The shut-off valve portion 132 can be a ¾ in. PVC schedule 40 S×S ball valve with EPDM Seats and O-rings. The purpose of the shut-off valve portion 132 is to keep the vacuum, pressurized air, and/or pressurized water from leaking into an A/C unit drain pan.

A bell opening 106 is formed on a first end 104 of the pipe 102 as shown to enable coupling with a downstream end of the drain line (not shown). In one example, the second end 140 of pipe 102 has a bell opening as well (not shown). The first tee, portion 110 has a threaded portion 112. A hose bibb 114 is shown fluidly coupled with the threaded portion 112. The house bibb can be any metal or plastic hose bib. Likewise, the second tee portion 120 has a threaded portion 122 is fluidly coupled with a compressed air portion 124 such as a ¼ in.×¼ in. NPT female industrial coupler. For example first tee and/or second tee are similar ¾ 4 in×¾ in×¾ in portion pipe size, schedule 40. However, the threads must be adapted to correctly fluidly coupled with the NPT female industrial coupler and/or the hose bibb.

The pipe 102 may be made out of any material, including plastic, metal, composite or a combination thereof. It is typical for AC drain pipes to be made from PVC. It is important to note that the pipe can be any length and any diameter. The diameter can be ½ inch, ¾ inch, 1 inch, 1¼ inch, 1½ inch, 1¾ inch, 2 inches, or a combination thereof. The interior portions of the pipe are formed to be as smooth as possible without ridges due to connections and couplings. The purpose of the smooth interior is to reduce areas that can trap dirt and debris wherever possible.

The pipe 102 may be molded into one or more pieces. For example, the two tee portions 110 and 120, end 104, shut-off valve portion 132, and end 140 may be formed as one unitary unit using injection molding techniques. In another example, the two tee portions 110 and 120, and end 104 are formed as one unitary piece, and the shut-off valve portion 132 and end 140 are fabricated as a second piece and joined together using glue or sonic welding techniques.

It is important to note that although both a hose bibb 114 and compressed air fitting 124 is shown. Only one of these may be fluidly coupled, and the unused tee 110 or 120 capped with a male threaded plug or cap.

### Example 2 of AC Drain Line Cleanout Manifold

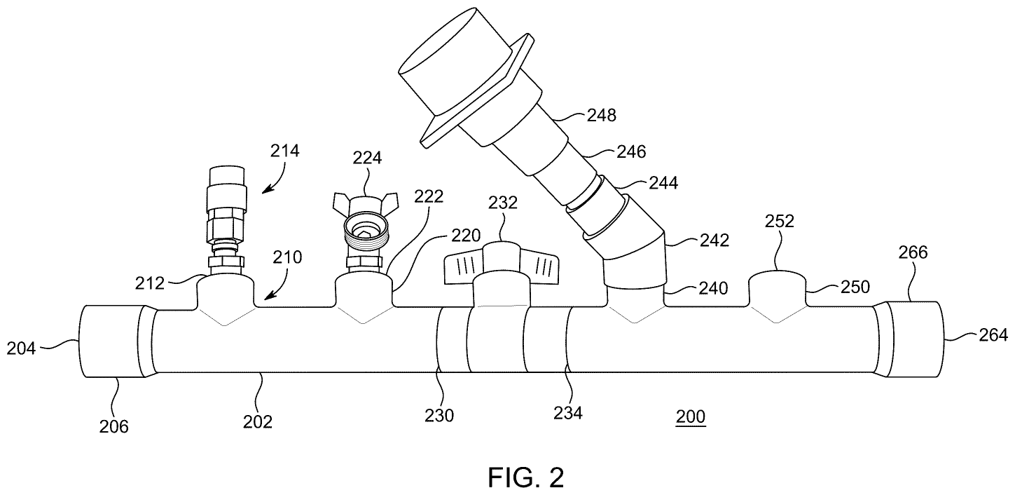

Turning to FIG. 2, shown is a side view of a second embodiment of an air conditioning drain cleanout manifold 200, according to one aspect of the present invention. Like the first embodiment 100 shown in FIG. 1, in this second embodiment, the manifold 200 includes a pipe 202 with two threaded tee portions 210, 220, and shut-off valve portion 232.

A bell opening 206 is formed on a first end 204 of the pipe 202, as shown to enable coupling with a downstream end of the drain line (not shown). In one example, the second end 264 of the pipe 202 has a bell opening 264. The first tee portion 210 has a threaded portion 212. A hose bibb 214 is shown fluidly coupled with the threaded portion 212. The hose bibb can be any metal or plastic hose bib. Likewise, the second tee portion 220 has a threaded portion 222 is fluidly coupled with a compressed air portion 224.

Adjacent to the shut-off valve portion 232 in this second embodiment is a section with two tee portions 240, 250, and end 264 with bell 266, as shown. Tee portion 240 is made to interface with couplers 242, 244, 246, for a vacuum interface 248. One example of a vacuum interface is a Rigid® brand that connects to a vac for clean & easy debris containment, which adapts to most wet-dry vacuums with a 2½″ hose. Being closer to the AC drain pan and the vacuum interface allows pulling water from the drain pan when the valve 232 is closed to prevent vacuum leakage back through the drain line.

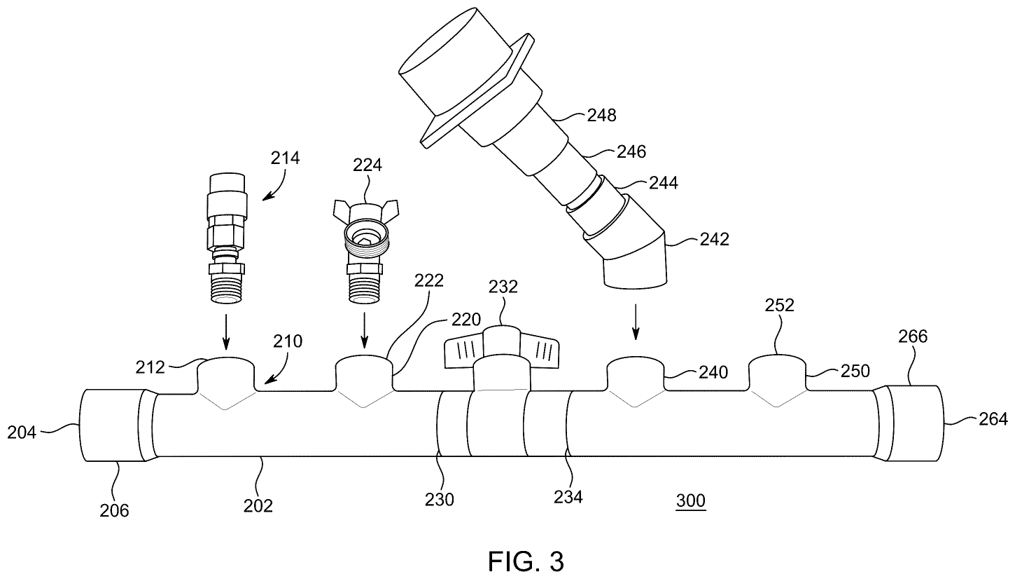

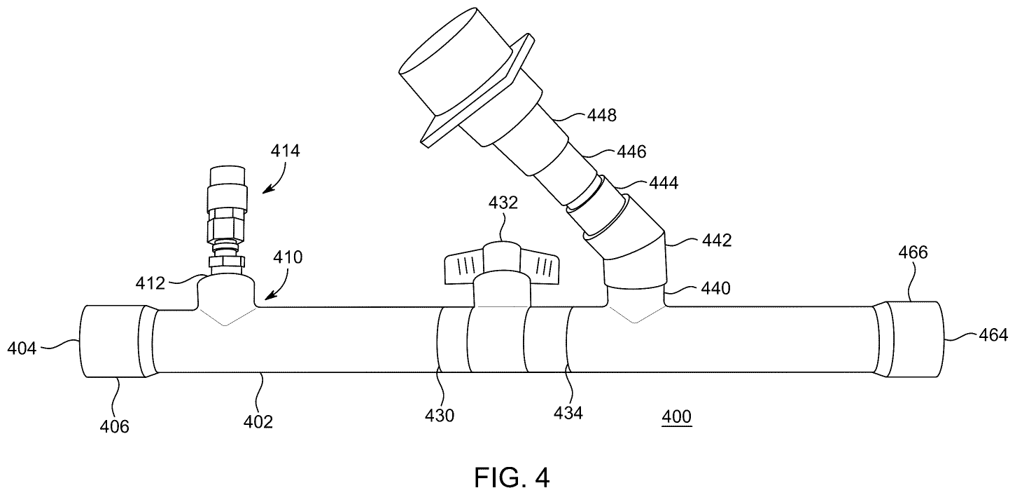

The tee portion 250 has an opening 252 that may accept a float switch, such as a Rectorseal float switch. Or in embodiment 3 400 shown in FIG. 4, the tee portion 250 is eliminated. All the remaining references number 4xx correspond to those described for 3xx in FIG. 3.

The pipe 202 may be made out of any material, including plastic, metal, composite or a combination thereof. It is typical for AC drain pipes to be made from PVC. It is important to note that the pipe can be any length and any diameter. The diameter can be ½ inch, ¾ inch, 1 inch, 1¼ inch, 1½ inch, 1¾ inch, 2 inches, or a combination thereof. The interior portions of the pipe are formed to be as smooth as possible without ridges due to connections and couplings. The purpose of the smooth interior is to reduce areas that can trap dirt and debris where ever possible.

The pipe 202 may be molded in one or more pieces. For example, the two tee portions 210 and 220, end 204, the valve portion 232, and end 234 may be formed as one unitary unit using injection molding techniques. In another example, the two tee portions 210 and 220, and end 204 are formed as one unitary piece, and the valve portions 230, 232, 234 are fabricated as a second piece and a second double tee portion 240, 250, and end 264 formed as a third unitary piece. Each of the first, second, and third unitary pieces is joined together using glue or sonic welding techniques.

Again, it is important to note that although both a hose bibb 214 and compressed air coupler 224 and couplers 242, 244, 246, for a vacuum interface 248 are shown. Only one of these may be connected and the unused tee 210 or 220 or 240 capped with a male threaded plug or cap.

### Example 3 of AC Drain Line Cleanout Manifold

Turning to FIG. 4, a side view of a second embodiment of an air conditioning drain cleanout manifold 400 is shown, according to one aspect of the present invention. Like the second embodiment 300 shown in FIG. 3, in this third embodiment, the manifold 200 includes a pipe 202 with one threaded tee portion 410, shut-off valve portion 432, and second tee 440 closer to the connection a the AC drain pan.

### Example 4 of AC Drain Line Cleanout Manifold

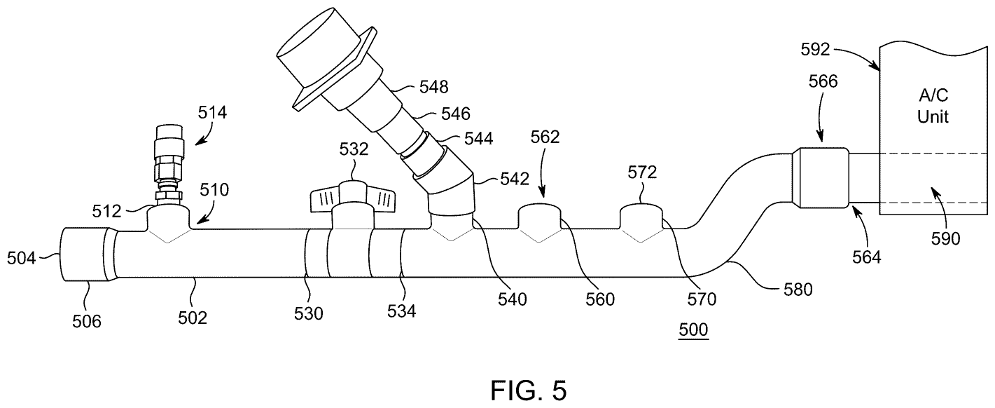

Turning to FIG. 5, a side view of a fourth embodiment of an air conditioning drain cleanout manifold 500 is shown, according to one aspect of the present invention. Like the third embodiment 400 shown in FIG. 4, in this fourth embodiment, the manifold 500 includes a pipe 202 with threaded tee portion 510, shut-off valve portion 532, and two more tee portions 560 and 572 for accepting auxiliary float switch and an opening to put chemical cleaners, such as Green Gobbler Main Line Cleaner and tablets such as Clear Drain Opener, such as AC Safe Pan Tablets. In this fourth embodiment, a bend 580 in pipe 502, as shown, keeps the height of the tee portions 560 and 572 below the drain pan 590. The height from the ground of the auxiliary float switch is lower than the drain pan 590 of the AC unit 592. This lower height causes the auxiliary float switch to sense water backing up in the drain line 502 before the drain pan becomes full, which is sensed by a primary float switch (not shown).

### Example 5 of AC Drain Line Cleanout Manifold

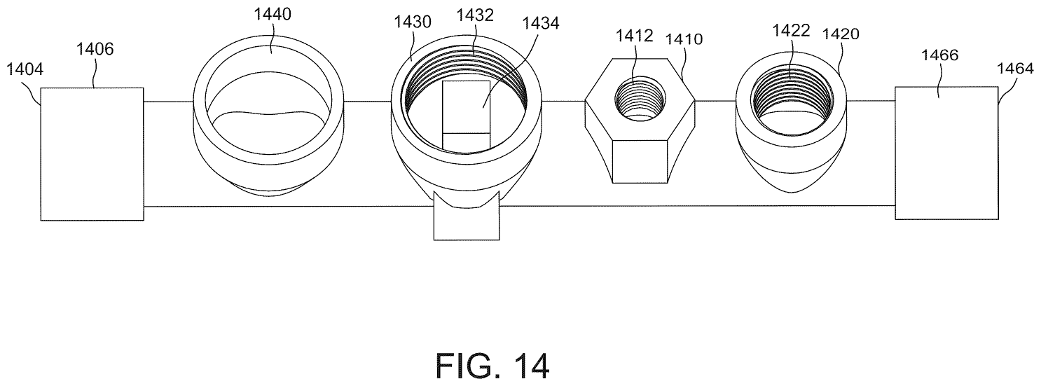

Turning to FIG. 14 shown is a perspective view of a fifth embodiment of an air conditioning drain cleanout manifold 1400, according to one aspect of the present invention.

This embodiment features a pipe 1402 fabricated with a one-piece continuous wall.

Fabrication techniques in this embodiment include additive manufacturing, such as three-dimensional printing, injection molding, and extrusion.

Like the second embodiment 200 shown in FIG. 2, in this second embodiment, the manifold 1400 includes the pipe 1402 with two threaded tee portions 1410, 1420, and shut-off valve portion 1432.

A bell opening 1406 is formed on a first end 1404 of the pipe 1402 as shown to enable coupling with a downstream end of the drain line (not shown). In one example, the second end 1464 of the pipe 1402 has a bell opening 1464. The first tee portion 1410 has a threaded portion 1412. A hose bibb 1414 is shown fluidly coupled with the threaded portion 1412. The hose bibb can be any metal or plastic hose bib. Likewise, the second tee portion 1420 has a threaded portion 1422 is fluidly coupled with a compressed air portion 1424.

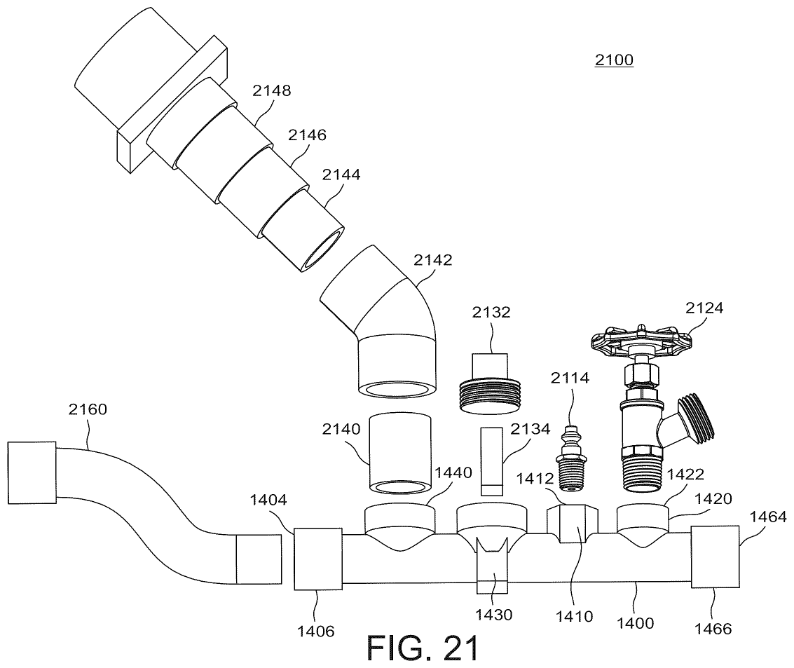

Adjacent to the shut-off valve portion 1432 in this fifth embodiment is a section with two tee portions 1440, 1450, and end 1464 with bell 1466, as shown. Tee portion 1440 is made to interface with couplers 2148, 2146, 2144, 2142 (as shown in FIG. 21) for a vacuum interface. One example of a vacuum interface is a Rigid® brand that connects to a vac for clean & easy debris containment, which adapts to most wet-dry vacuums with a 2½″ hose. Being closer to the AC drain pan and the vacuum interface allows pulling water from the drain pan when the valve 1432 is closed to prevent vacuum leakage back through the drain line. Also shown is a PVC extension pipe 2160 to couple this novel manifold with an AC drain.

The tee portion 1450 has an opening 1452 that may accept a float switch, such as a Rectorseal float switch. All the remaining references are described above.

The pipe 1402 may be made out of any material, including plastic, metal, composite, or a combination thereof. It is typical for AC drain pipes to be made from PVC. It is important to note that the pipe can be any length and any diameter. The diameter can be ½ inch, ¾ inch, 1 inch, 1¼ inch, 1½ inch, 1¾ inch, 2 inches, or a combination thereof. The interior portions of the pipe are formed to be as smooth as possible without ridges due to connections and couplings. The purpose of the smooth interior is to reduce areas that can trap dirt and debris where ever possible.

The pipe 1402 may be molded into one or more pieces. For example, the two tee portions 1410 and 1420, end 1404, valve portion 1432, and end 1434 may be formed as one unitary unit using injection molding techniques. In another example, the two tee portions 1410 and 1420, and end 1404 are formed as one unitary piece, and the valve portions 1430, 1432, 1434 are fabricated as a second piece and a second double tee portion 1440, 1450, and end 1464 formed as a third unitary piece. Each of the first unitary piece, the second unitary piece and third unitary piece joined together using glue or sonic welding techniques.

Again, it is important to note that although both a hose bibb 1414 and compressed air coupler 1424 and couplers 1442, 1444, 1446, for a vacuum interface 1448 are shown. Only one of these may be connected and the unused tee 1410 or 1420 or 1440 capped with a male threaded plug or cap.

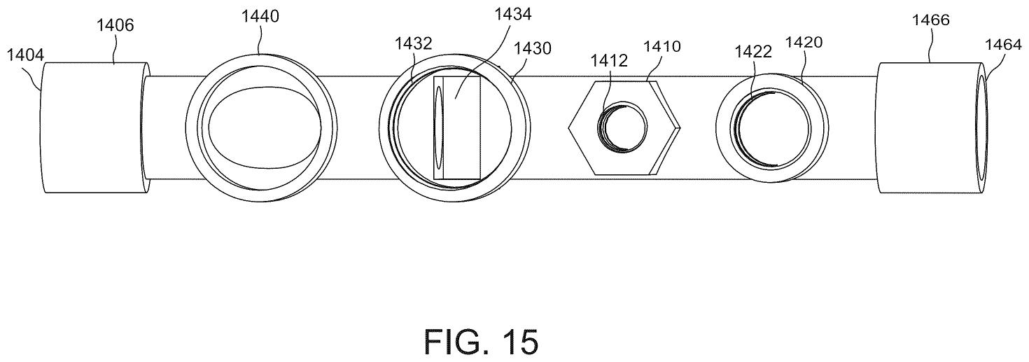

FIG. 15 is a top view FIG. 14, according to one aspect of the present invention.

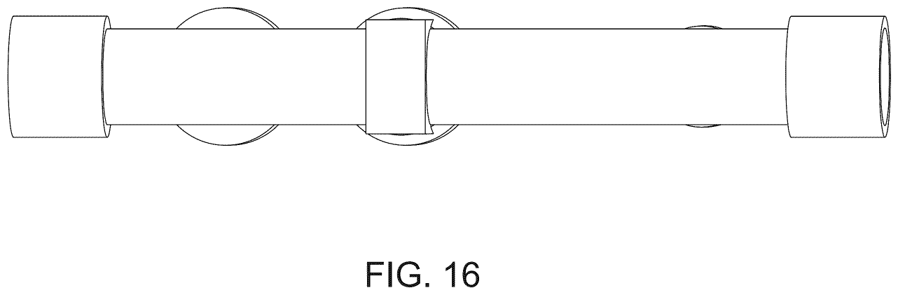

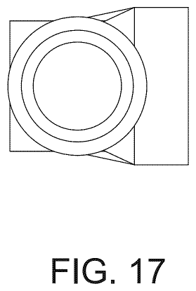

FIG. 16 is a bottom view FIG. 14, according to one aspect of the present invention.

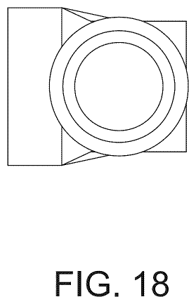

FIG. 17 is a first end view of FIG. 14, according to one aspect of the present invention.

FIG. 18 is a second end view of FIG. 14, according to one aspect of the present invention.

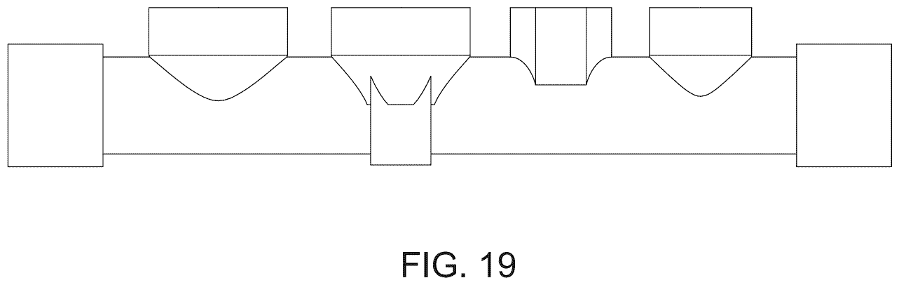

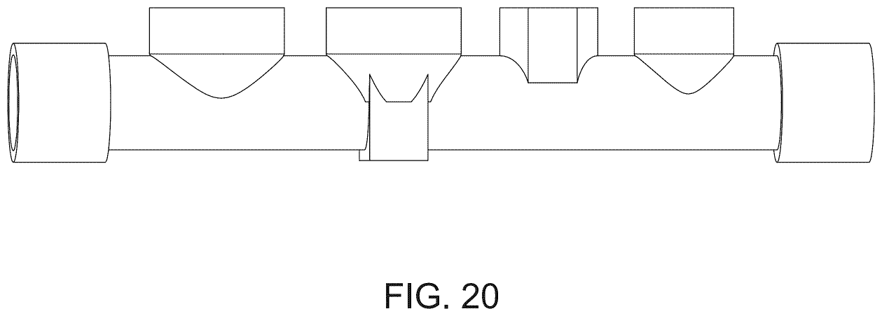

FIG. 19 is a first side view of FIG. 14, according to one aspect of the present invention.

FIG. 20 is a second side view of FIG. 14, according to one aspect of the present invention.

FIG. 21 is a side explosion view of FIG. 14 illustrating various adapters fluidly coupled to the air conditioning drain cleanout manifold, according to one aspect of the present invention.

Like other embodiments described above, in this fifth embodiment, the manifold 2100 includes a pipe 1400 with two threaded opening portions 1410, 1420, and shut-off valve threaded portion 1430.

A bell opening 1406 is formed on a first end 1404 of the pipe 1400 as shown to enable coupling with a downstream end of the drain line (not shown). In one example, the second end 1464 of the pipe 1402 has a bell opening 1464. The first opening portion 1410 has a threaded portion 1412. A hose bibb 1414 is shown fluidly coupled with the threaded portion 1412. The hose bibb can be any metal or plastic hose bib. Likewise, the second opening portion 1420 has a threaded portion 1422 is fluidly coupled with a compressed air portion 1424.

Adjacent to the shut-off valve portion 1432 in this second embodiment is a section with two opening portions 1440, 1450, and end 1464 with bell 1466, as shown. opening portion 1440 is made to interface with couplers 1442, 1444, 1446, for a vacuum interface 1448. One example of a vacuum interface is a Rigid® brand that connects to a vac for clean & easy debris containment, which adapts to most wet-dry vacuums with a 2½″ hose. Being closer to the AC drain pan and, the vacuum interface allows pulling water from the drain pan when the valve 1432 is closed to prevent vacuum leakage back through the drain line.

The opening portion 1450 has an opening 1452 that may accept a float switch, such as a Rectorseal float switch. Or in embodiment 3 400 shown in FIG. 4, the opening portion 1450 is eliminated. All the remaining reference numbers are previously described above.

The pipe 2100 may be made out of any material, including plastic, metal, composite or a combination thereof. It is typical for AC drain pipes to be made from PVC. It is important to note that the pipe can be any length and any diameter. The diameter can be ½ inch, ¾ inch, 1 inch, 1¼ inch, 1½ inch, 1¾ inch, 2 inches, metric sizes, or a combination thereof. The interior portions of the pipe are formed to be as smooth as possible without ridges due to connections and couplings. The purpose of the smooth interior is to reduce areas that can trap dirt and debris wherever possible.

The pipe 2100 may be molded in one or more pieces. For example, the two opening portions 1410 and 1420, end 1404, the valve portion with threaded opening 1430, threaded plug 2132 and flexible member 2134, and end 1434 may be formed as one unitary unit using injection molding techniques.

Again, it is important to note that although both a hose bibb 2124 and compressed air coupler 2114 and couplers 2142, 2144, 2146, for a vacuum interface 2148 are shown. Only one of these may be connected and the unused opening 1410 or 1420 or 1440 capped with a male threaded plug or cap (not shown).

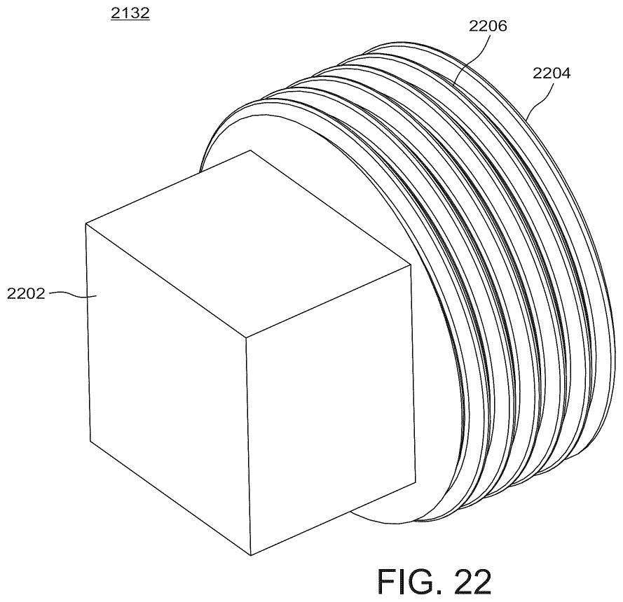

FIG. 22 is a perspective view of the threaded plug 2132 of FIG. 21. The threaded plug has a first end 2202 adapted, in this example a square head as shown 2204, to work with a wrench or driver. The threaded plug 2132 has a second end 2214, which is threaded 2216 to threadably engage the threads 1432.

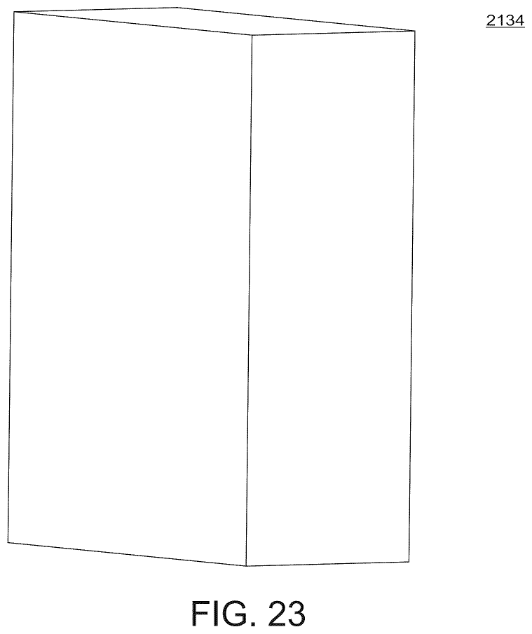

FIG. 23 is a perspective view of the flexible member 2134 adapted to fit into the slot 1434 and, along with the compression from the threaded plug 2132, acts as a shut-off valve when tightened. The flexible member 2134 is shown as a cube-shaped or cuboid-shaped, but other shapes and geometries are possible to act as a seal. The flexible member can be made from rubber, plastic, metal, composite or a combination thereof.

### Non-Limiting Examples

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An air conditioning drain cleanout manifold, comprising:
a pipe with a first end and a second end, the pipe formed with a first tee portion with a first threaded opening formed adjacent to the first end and a second tee portion formed with a second threaded opening formed adjacent to the first tee portion; and
a shut-off valve formed adjacent to the second tee portion and the second end, so that the first end, the first tee portion, the first threaded opening, the second tee portion, the second threaded opening, the shut-off valve and the second end are all in fluid communications.

2. The air conditioning drain cleanout manifold of claim 1, wherein at least one of the first threaded opening, the second threaded opening, or both is formed with pipe threads to threadably and fluidly coupled with a hose bib.

3. The air conditioning drain cleanout manifold of claim 1, wherein at least one of the first threaded opening, the second threaded opening, or both is formed with pipe threads to threadably and fluidly coupled with a compressed air portion.

4. The air conditioning drain cleanout manifold of claim 1, further comprising:
at least a third tee portion formed on a side of the shut-off valve that is opposite the second tee portion and in fluid communications therewith.

5. An aftermarket air conditioning drain cleanout manifold, comprising:
a pipe fabricated with a one-piece continuous wall with a first end and a second end, the pipe formed in fluid communication with
a first threaded opening formed perpendicular to the one-piece continuous wall and adjacent to the first end,
a second threaded opening formed perpendicular to the one-piece continuous wall and adjacent to the first threaded opening,
a third threaded opening formed perpendicular to the one-piece continuous wall and adjacent to the second threaded opening and a slot formed within the opening of the third threaded opening and perpendicular to the one-piece continuous wall of the pipe, and
a fourth opening, formed perpendicular to the one-piece continuous wall and adjacent to the third threaded opening; and
a flexible member disposed in the slot and a threaded plug adapted to engage the third threaded opening to form a shut-off valve.

6. The aftermarket air conditioning drain cleanout manifold of claim 5, wherein the pipe is fabricated using an injection mold process.

7. The aftermarket air conditioning drain cleanout manifold of claim 5, wherein the pipe is fabricated using an additive manufacturing process.

8. The aftermarket air conditioning drain cleanout manifold of claim 5, wherein at least one of the first threaded opening, the second threaded opening, or both is formed with female garden hose threads to threadably and fluidly coupled with a garden hose bib.

9. The aftermarket air conditioning drain cleanout manifold of claim 5, wherein at least one of the first threaded opening, the second threaded opening, or both is formed with pipe threads to threadably and fluidly coupled with a ¼ inch national pipe tapered (NPT) threaded male compressed air plug.

10. The aftermarket air conditioning drain cleanout manifold of claim 5, wherein the fourth opening has a ¾ inch opening to accept a vertical float switch thereinto.

11. The aftermarket air conditioning drain cleanout manifold of claim 5,
wherein at least one of the first threaded opening, the second threaded opening, or both is formed with female garden hose threads to threadably and fluidly coupled with a garden hose bib,
wherein at least one of the first threaded opening, the second threaded opening, or both is formed with pipe threads to threadably and fluidly coupled with a ¼ inch national pipe tapered (NPT) threaded male compressed air plug, and
wherein the fourth opening has a ¾ inch opening to accept a vertical float switch thereinto.

12. The aftermarket air conditioning drain cleanout manifold of claim 5, wherein the flexible member is a cube-shaped or cuboid-shaped.

13. The aftermarket air conditioning drain cleanout manifold of claim 12, wherein the flexible member is fabricated out of plastic, metal, composite, or a combination thereof.

14. The aftermarket air conditioning drain cleanout manifold of claim 5, wherein the pipe is fabricated out of plastic, metal, composite, or a combination thereof.

15. An aftermarket air conditioning drain cleanout manifold, comprising:
a pipe fabricated with a one-piece continuous wall with a first end and a second end, the pipe formed in fluid communication with
a first threaded opening formed perpendicular to the one-piece continuous wall and adjacent to the first end,
a second threaded opening formed perpendicular to the one-piece continuous wall and adjacent to the first threaded opening and a slot formed within the opening of the second threaded opening and perpendicular to the one-piece continuous wall of the pipe; and
a flexible member disposed in the slot and a threaded plug adapted to engage the second threaded opening to form a shut-off valve.

16. The aftermarket air conditioning drain cleanout manifold of claim 15, wherein the pipe fabricated with the one-piece continuous wall further comprises:
a third threaded opening formed perpendicular to the one-piece continuous wall and adjacent to the second threaded opening and a slot formed within the opening of the third threaded opening and perpendicular to the one-piece continuous wall of the pipe, and
a fourth opening, formed perpendicular to the one-piece continuous wall and adjacent to the third threaded opening.

17. The aftermarket air conditioning drain cleanout manifold of claim 15, wherein the pipe is fabricated using an injection mold process or an additive manufacturing process.

18. The aftermarket air conditioning drain cleanout manifold of claim 15, wherein at least one of the first threaded opening, the second threaded opening, or both is formed with female garden hose threads to threadably and fluidly coupled with a garden hose bib.

19. The aftermarket air conditioning drain cleanout manifold of claim 15, wherein at least one of the first threaded opening, the second threaded opening, or both is formed with pipe threads to threadably and fluidly coupled with a ¼ inch national pipe tapered (NPT) threaded male compressed air plug.

20. The aftermarket air conditioning drain cleanout manifold of claim 16, wherein the fourth portion has a ¾ inch opening to accept a vertical float switch thereinto.

21.-24. (canceled)
